(19) United States
(12) Patent Application Publication
(10) Pub. No.: US 2024/0080502 A1
(43) Pub. Date: Mar. 7, 2024

(54) HANDOVER OF CAPTURING OF A MEDIA STREAM

(71) Applicant: Telefonaktiebolaget LM Ericsson (publ), Stockholm (SE)

(72) Inventors: Tommy ARNGREN, Södra Sunderbyn (SE); Peter ÖKVIST, Luleå (SE); Andreas KRISTENSSON, Södra Sandby (SE)

(21) Appl. No.: 18/270,051

(22) PCT Filed: Mar. 19, 2021
(86) PCT No.: PCT/EP2021/057102

§ 371 Date: Jun. 28, 2023

(51) Int. Cl. H04N 21/218; H04N 21/2187

(52) U.S. Cl. CPC H04N 21/21805; H04N 21/2187

(57) ABSTRACT

It is provided a method for performing a handover of capturing of a media stream from a source device to a target device. The method is performed in the source device and includes the steps of: capturing the media stream; storing data corresponding to the media stream in a server location; determining a target device; providing a handover signal to the target device, the handover signal including an indication of the server location; receiving a handover response, indicating that handover is accepted by the target device; and determining that media capturing has been handed over to the target device.

### TECHNICAL FIELD

The present disclosure relates to the field of capturing a media stream and in particular to performing a handover of capturing of a media stream from a source device to a target device.

### BACKGROUND

Smartphones of today are capable of recording high quality video and audio in many different contexts ranging from podcasts to family situations.

There are many different advanced desktop applications for post editing of videos that makes it possible to add effects, cut and append video clips together, etc. Also, different types of editing, from basic trimming to adding transitions, titles, and effects is simple on both iOS and Android mobile devices, e.g. Apple's own iMovie for iPhone and numerous other apps.

Moreover, there are solutions for storing media data in the cloud, including iCloud, which is built into the iPhone, as well as Google Photos, which is a photo-sharing and video-sharing app. Amazon and Dropbox also have cloud storage solutions popular with consumers.

Despite all video capabilities included in smartphones and media productions of today, it is very cumbersome to combine media streaming capturing of multiple smartphones. The only way that this can be done is to record two separate media streams (separate video files from two separate devices) and afterwards combine them into one video file using post editing tools. This requires additional work and there might be a significant timing gap and different camera settings visible in the combined recording.

### SUMMARY

One object is to simplify how media streams from multiple user devices are combined into a single media stream.

According to a first aspect, it is provided a method for performing a handover of capturing of a media stream from a source device to a target device. The method is performed in the source device and comprises the steps of: capturing the media stream; storing data corresponding to the media stream in a server location; determining a target device; providing a handover signal to the target device, the handover signal comprising an indication of the server location; receiving a handover response, indicating that handover is accepted by the target device; and determining that media capturing has been handed over to the target device.

The method may further comprise the step of: ending capturing the media stream and storing data corresponding to the media stream after the handover is complete.

The handover signal may comprise an indication of when the handover is to occur.

The step of determining that the media capturing is handed over may comprise determining that media capturing has been handed over to the target device based on the time, according to the indication of when the handover is to occur, has passed.

The method may further comprise the step of: synchronising clocks with the target device.

The step of providing the handover signal may comprises providing data in the form of an optical code on a display of the source device.

The step of determining a target device may comprise determining a target device in a group of prioritised target devices, if such a target device is available.

The step of determining a target device may comprise determining a target device based on a location of the source device and a location of the target device.

The indication of server location may comprise an indication of a file in which the target device should store captured media stream data after the handover.

The handover signal may comprise information of how the media stream should be captured, wherein the information comprises at least one of: a direction of media capture, a position for media capture, a time of when handover is to occur, one or more camera settings, and an object to focus on.

The method may be triggered based on a scheduled event detected in the source device, an incoming call in the source device or that a battery level of the source device is under a threshold.

The media stream may comprise video data and/or audio data.

According to a second aspect, it is provided a source device for performing a handover of capturing of a media stream from the source device to a target device. The source device comprises: a processor; and a memory storing instructions that, when executed by the processor, cause the source device to: capture the media stream; store data corresponding to the media stream in a server location; determine a target device; provide a handover signal to the target device, the handover signal comprising an indication of the server location; receive a handover response, indicating that handover is accepted by the target device; and determine that media capturing has been handed over to the target device.

The source device may further comprise instructions that, when executed by the processor, cause the source device to: end capturing the media stream and storing data corresponding to the media stream after the handover is complete.

The handover signal may comprise an indication of when the handover is to occur.

The instructions to determine that the media capturing is handed over may comprise instructions that, when executed by the processor, cause the source device to determine that media capturing has been handed over to the target device based on the time, according to the indication of when the handover is to occur, has passed.

The source device may further comprise instructions that, when executed by the processor, cause the source device to: synchronise clocks with the target device.

The instructions to provide the handover signal may comprise instructions that, when executed by the processor, cause the source device to provide data in the form of an optical code on a display of the source device.

The instructions to determine a target device may comprise instructions that, when executed by the processor, cause the source device to determine a target device in a group of prioritised target devices, if such a target device is available.

The instructions to determine a target device may comprise instructions that, when executed by the processor, cause the source device to determine a target device based on a location of the source device and a location of the target device.

The indication of server location may comprises an indication of a file in which the target device should store captured media stream data after the handover.

The handover signal may comprise information of how the media stream should be captured, wherein the information comprises at least one of: a direction of media capture, a position for media capture, a time of when handover is to occur, one or more camera settings, and an object to focus on.

The instructions may be triggered based on a scheduled event detected in the source device, an incoming call in the source device or that a battery level of the source device is under a threshold.

The media stream may comprise video data and/or audio data.

According to a third aspect, it is provided a computer program for performing a handover of capturing of a media stream from a source device to a target device. The computer program comprises computer program code which, when executed on a source device causes the source device to: capture the media stream; store data corresponding to the media stream in a server location; determine a target device; provide a handover signal to the target device, the handover signal comprising an indication of the server location; receive a handover response, indicating that handover is accepted by the target device; and determine that media capturing has been handed over to the target device.

According to a fourth aspect, it is provided a computer program product comprising a computer program according the third aspect and a computer readable means on which the computer program is stored.

According to a fifth aspect, it is provided a method for performing a handover of capturing of a media stream from a source device to a target device. The method is performed in the target device and comprises the steps of: receiving a handover signal from the source device, the handover signal comprising an indication of a server location; determining that handover is accepted; transmitting a handover response, indicating that handover is accepted by the target device; capturing the media stream in accordance with the handover signal; and storing data corresponding to the media stream in the server location.

The handover signal may comprise an indication of when the handover is to occur.

The method may further comprise the step of: synchronising with the source device.

The handover signal may comprise configuration information of how the media stream should be captured by the target device in which case the step of capturing the media stream comprises applying at least part of the configuration information.

The step of receiving the handover signal may comprise reading data in the form of an optical code on a display of the source device.

The indication of media stream storage may comprise an indication of a file in which the target device should store captured media stream data after the handover.

The media stream may comprise video data.

The media stream may comprise audio data.

According to a sixth aspect, it is provided a target device for performing a handover of capturing of a media stream from a source device to the target device. The target device comprises: a processor; and a memory storing instructions that, when executed by the processor, cause the target device to: receive a handover signal from the source device, the handover signal comprising an indication of a server location; determine that handover is accepted; transmit a handover response, indicating that handover is accepted by the target device; capture the media stream in accordance with the handover signal; and store data corresponding to the media stream in the server location.

The handover signal may comprise an indication of when the handover is to occur.

The target device may further comprise instructions that, when executed by the processor, cause the target device to: synchronise with the source device.

The handover signal may comprise configuration information of how the media stream should be captured by the target device. in which case the instructions to capture the media stream instructions that, when executed by the processor, cause the target device to apply at least part of the configuration information.

The instructions to receive the handover signal may comprise instructions that, when executed by the processor, cause the target device to read data in the form of an optical code on a display of the source device.

The indication of media stream storage may comprise an indication of a file in which the target device should store captured media stream data after the handover.

The media stream may comprise video data and/or audio data.

According to a seventh aspect, it is provided a computer program for performing a handover of capturing of a media stream from a source device to a target device. The computer program comprises computer program code which, when executed on the target device causes the target device to: receive a handover signal from the source device, the handover signal comprising an indication of a server location; determine that handover is accepted; transmit a handover response, indicating that handover is accepted by the target device; capture the media stream in accordance with the handover signal; and store data corresponding to the media stream in the server location.

According to an eighth aspect, it is provided a computer program product comprising a computer program according to the seventh aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic drawing illustrating an environment in which embodiments presented herein can be applied;

FIGS. 2A-B are sequence diagrams illustrating communication between various entities of FIG. 1 for handover of capturing of a media stream;

FIGS. 3A-B are flow charts illustrating embodiments of methods for performing a handover of capturing of a media stream, performed in a source device;

FIGS. 4A-B are flow charts illustrating embodiments of methods for performing a handover of capturing of a media stream, performed in a target device;

FIG. 5 is a schematic diagram illustrating components of the user devices, being the source device or target device of FIG. 1 according to one embodiment;

FIG. 6 is a schematic diagram showing functional modules of the source device of FIG. 1 according to one embodiment;

FIG. 7 is a schematic diagram showing functional modules of the target device of FIG. 1 according to one embodiment; and

FIG. 8 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, it is provided a solution for seamless handover of media stream capturing from a source device (e.g. a smartphone) to a target device (e.g. also a smartphone). The handover can be triggered based on any suitable event, such as manual indication, low battery, incoming call, scheduled event, reminder, alarm, etc. The handover can convey information in a handover signal about camera parameters and synchronization information for a smooth handover transition. The handover signal can be provided to the target device based on wireless communication, optical code, etc.

Based on the handover signal, the target device can adapt its camera settings to match (as good as possible) the camera settings indicated in the handover signal. The media capture of both devices will then sync or overlap in the handover of media capture.

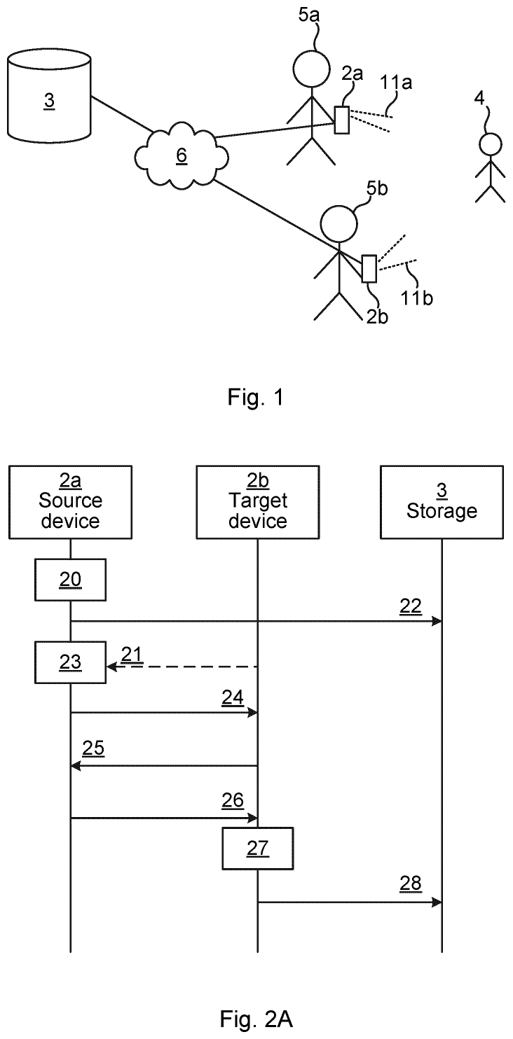

FIG. 1 is a schematic drawing illustrating an environment in which embodiments presented herein can be applied. There is here shown a first user 5a and a second user 5b. The first user has a user device 2a, herein after denoted a source device 2a. The source device 2a is capturing media, e.g. as a video and audio stream of a first field of view 11a for capturing a subject 4. It is to be noted that there may be more users and respective user devices than are shown in FIG. 1.

The source device 2a can e.g. be a smartphone, a tablet computer, a wearable device, a video camera, etc. The source device 2a captures the media stream and stores this in a storage device 3. The storage device 3 and the source device 2a can communicate over a communication network 6. The communication network 6 can be a wide area network 6, such as the Internet, and can be based on several communication links as known in the art per se, e.g. over a cellular network, WiFi, optical network, wired network, etc. A second user 5b has another user device, hereinafter denoted a target device 2b. The target device 2b is also capable of capturing a media stream, e.g. as a video and audio stream of a second field of view lib for capturing the subject 4.

According to embodiments presented herein, the source device 2a performs a handover of capturing of a media stream to the target device 2b to ensure continued media capture of the subject 4, even after the source device 2a ends media stream capturing, due to any of a range of different reasons as explained in more detail below.

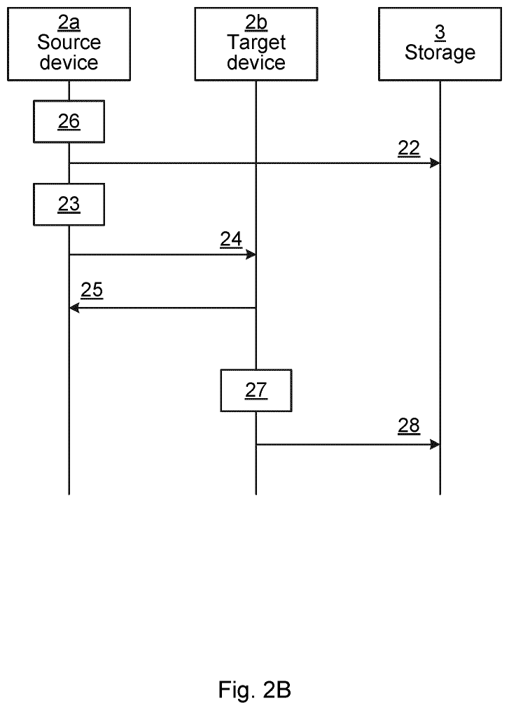

FIGS. 2A-B are sequence diagram illustrating communication between various entities of FIG. 1 for handover of capturing of a media stream.

First, the sequence illustrated in FIG. 2A will be described. The source device 2a captures 20 the media stream and stores 22 corresponding data in the storage device 3.

The source device 2a is then triggered 23 to perform a handover of the media stream capture to the target device, whereby the source device 2a provides a handover signal 24 to the target device 2b. As described in more detail below, the trigger for the handover can be an event determined in the source device 2a.

Alternatively, the handover is triggered by the target device 2b, in which case the target device 2b transmits an optional handover request signal 21 to the source device 2a. Prior to such a handover request signal 21, the source device optionally announces (not shown) to the target device 2b (and optionally to other potential target devices) the ability of the target device 2a to perform the handover. The handover can be triggered by the target device 2b e.g. in a scenario where the second user 2b observes the first user 2a capturing a scene with the source device 5a, where the second user 5b, (instead of receiving a signal requesting handover) observes some cause for handover, e.g. that the source device 2a is about to run out of battery. In this case, a decision to do a handover can be made without having to rely on signalling trigger such a request.

The target device, in response, transmits a handover response 25, indicating that the handover is accepted by the target device 2b.

Once the handover is to occur, the source device 2a transmits a handover command 26 to the target device 2b. After this, the target device 2b captures 27 the media stream and stores 28 the corresponding data in the storage 3. It is to be noted that the storage could optionally be located in the source device 2a and/or target device 2b, as long as both devices 2a, 2b can be given access to the storage. Optionally, in parallel to storing the media stream data in the (e.g. cloud) storage, the media stream data can be stored locally in the device capturing the media stream (i.e. the source device 2a and/or target device 2b depending on the point in time).

In the sequence shown in FIG. 2B, there is no handover command from the source device 2a to the target device 2b. Instead, the target device knows when to take over the capturing of the media stream, e.g. at a particular time that is indicated in the handover signal 24 and/or the handover response 25.

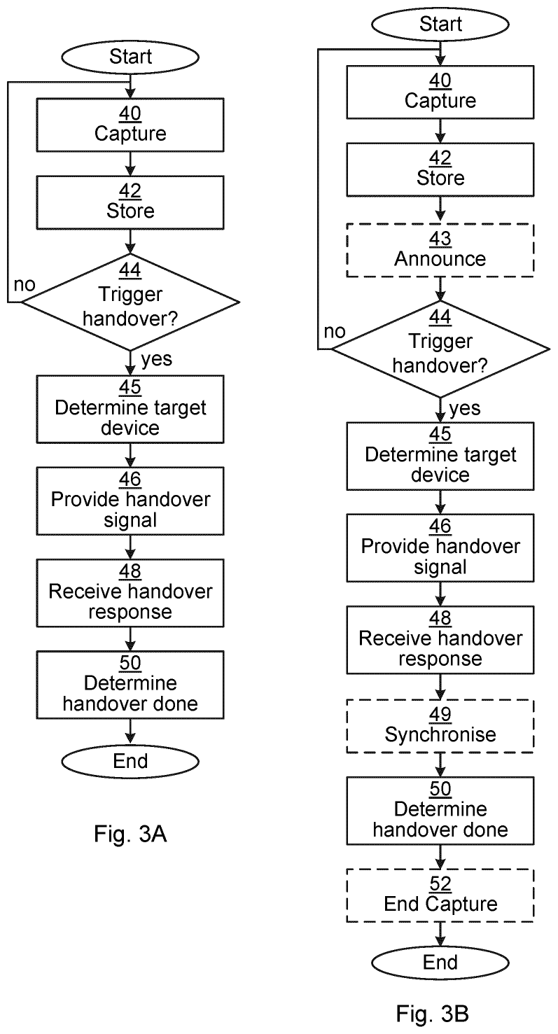

FIGS. 3A-B are flow charts illustrating embodiments of methods for performing a handover of capturing of a media stream, performed in a source device 2a. The handover occurs from the source device 2a to a target device 2b.

In a capture step 40, the source device 2a captures the media stream. The media stream can comprise video data and/or audio data. The media stream is captured e.g. using a camera and/or a microphone. The camera can be configured with certain parameters for the media capture, depending e.g. on light conditions, distance to subject, etc.

In a store step 42, the source device 2a stores data corresponding to the media stream in a server location. It is to be noted that the storing of data in step 42 can be performed in parallel with media stream capture in the capture step 40. The server can be in what is commonly known as ‘the cloud’.

In parallel to steps 40 and 42, in an optional announce step 43, the source device 2a announces its ability to act as a source for a handover of capturing of a media stream. This announcement can be received by a target device and can be indicated as an icon on the display of the target device, allowing the target device to initiate the handover by pressing the icon or speech command to reduce disturbance to any ongoing recording.

In a conditional trigger handover step 44, the source device 2a determines whether it should perform a handover procedure, i.e. if the handover procedure is triggered. The handover can be triggered based on user input, i.e. a manual handover trigger using the user interface of the source device. Alternatively, the handover can be triggered based on a handover request signal 21 from a target device 2b. Optionally, the handover request signal 21 comprises a time for handover, suggested by the target device. This time can be a firm (take it or leave it) time or it can be a suggestion for the source device to consider and comply with, if it is suitable. Alternatively, the handover can be triggered based on a scheduled event detected in the source device 2a. Alternatively, the handover can be trigged when an incoming call occurs in the source device 2a. Alternatively, the handover can be triggered when a battery level of the source device 2a is under a threshold level. Alternatively, the handover can be triggered when local storage in source device is becoming full, indicated by remaining free space being less than a threshold amount. Alternatively, the handover can be triggered when local storage in source device is running out of its quota for cellular data.

If the handover is triggered, the method proceeds to a determine target device step 45. Otherwise, the method returns to the capture step 40.

In the determine target device step 45, the source device 2a determines a target device 2b for which the media stream capturing should be handed over to. This determination can comprise determining a target device in a group of prioritised target devices (e.g. devices of family members), if such a target device is available. Alternatively or additionally, the determining of target device comprises determining a target device based on a location of the source device 2a and a location of the target device 2b.

Optionally, the target device is selected based on device parameters of candidate target devices. For instance, for an evening concert, the target device can require that a target device has a camera with a specified low light capability.

Optionally, the device parameters (e.g. camera capabilities, etc.) of the candidate target device are determined by querying a server storing such device capabilities. This query can be based on an identity of a candidate target device or a model identifier and/or an operating system version of the candidate target device.

If there are several candidate target devices for the handover, several parameters can be combined for each candidate target device in a weighted composite matching score. The candidate target device with the best matching score is then selected to be the target device for the handover.

When it is the target device 2b that triggers the handover by transmitting a handover request 21 to the source device, this step simply determines the target device 2b to be the device that transmitted the handover request 21. By determining the target device 2b, the source device 2a has determined to accept the handover according to the handover request 21. It is to be noted that when the target device triggers the handover, this step can optionally be performed prior to step 44.

Depending on the trigger of the handover, the time until the handover may be short or long. For instance, when the trigger is an incoming phone call, the handover needs to occur quickly, while when the trigger is low battery level, there may be some time until the handover needs to be performed. Depending on the time until the handover is to be performed, the target device can be determined more strictly or less strictly. For instance, if there is an incoming call as a trigger, the source device cannot be so selective when selecting the target device, since the handover needs to occur very quickly; it is then important to find any feasible target device that can accept the handover as soon as possible.

In a provide handover signal step 46, the source device 2a provides a handover signal to the target device 2b. The handover signal comprises an indication of the server location. Optionally, the handover signal comprises an indication of when the handover is to occur, i.e. a handover time indicating a point in time when responsibility for media stream capture is transferred from the source device to the target device.

In one embodiment, the indication of server location comprises an indication of a file in which the target device 2b should store captured media stream data after the handover. The server location can be in the form of a URI (Uniform Resource Indicator), indicating a specific file or server directory to which the media capturing is to be recorded.

When it is the target device 2b that triggers the handover, the handover signal can comprise an indication for the target device to control the actual handover.

Optionally, the handover signal comprises information of how the media stream should be captured. For instance, the handover signal can comprise an indication of a direction (field of view) of media stream capture. Alternatively or additionally, the handover signal can comprise an indication of a position of the source device and/or subject for media stream capture. Alternatively or additionally, the handover signal can comprise an indication of a time of when handover is to occur. Alternatively or additionally, the handover signal can comprise an indication of one or more camera settings. Alternatively or additionally, the handover signal can comprise camera parameters, such as resolution, frame rate, white balance, filter setting, indication of subject, etc.

The handover signal can be implemented in data of an optical code on a display of the source device 2a. The source device 2a can then display the optical code on the display of the source device 2a. Modern optical codes can contain a lot of data, whereby a target device can receive all this data of the handover signal simply by reading the optical code. In such a solution, the handover signal is provided to the target device without using radio-based wireless communication, such as Bluetooth, WiFi, etc. The optical code can e.g. be based on a QR (Quick Response) code, a point cloud code or other static or dynamic two-dimensional (or three-dimensional) optical codes. When the source device comprises a display that covers one or more sides of the source device 2a, the optical code can be provided on a side display part, to allow the target device to read the handover signal while the user of the source device 2a can see the camera capture on the main display panel to ensure that the media stream capture proceeds with the best possible capture quality.

Alternatively, the handover signal is provided to the target device using wireless communication, Short Message Service (SMS), other messaging service (WhatsApp, iMessage, etc.), device-to-device bump (detected using accelerometers of the source device and target device).

The handover signal can be contained in a single data item provided to the target device 2b, or the handover signal can be split over several data items that are provided to the target device 2b.

Optionally, the handover signal comprises connection parameters, to allow the target device to connect to the source device directly over local communication, or via the communication network 6.

Optionally, the target device 2b needs to authenticate with the source device 2a for the handover to proceed. The authentication can depend on the identity of the target device 2b. For instance, if the target device 2b belongs to a family member of the user of the source device (according to a predefined list of users or user devices), no authentication might be needed, while if the target device belongs to a stranger, stronger authentication may be needed.

Optionally, the handover signal is transmitted to a plurality of target devices, where the first one to accept the handover will be the selected target device to hand over the media stream capture to. In such a case, the handover signal can be transmitted first to a group of prioritised devices (e.g. family members), followed by devices that are in a contacts application of the source device, and lastly devices that are completely unknown.

In a receive handover response step 48, the source device 2a receives a handover response, indicating that handover is accepted by the target device 2b.

Alternatively, the handover response indicates what device parameters can be matched by the target device. If the source device considers this insufficient, the source device may go back to the determine target device step 45 and select another target device.

In a determine handover done step 50, the source device 2a determines that media capturing has been handed over to the target device 2b. In one embodiment, this is determined based on the time, according to the indication of when the handover is to occur, has passed. Alternatively, this is based on receiving a message from the target device 2b confirming that it is assuming responsibility of capturing the media stream.

Looking now to FIG. 3B, only new of modified steps, compared to FIG. 3A, are described.

In an optional synchronise step 49. the source device 2a synchronising clocks with the target device 2b. The synchronisation allows the reliable determination of the handover time at both the source device 2a and the target device 2b, ensuring no gaps in the resulting combined media file.

In an optional end capture step 52, the source device 2a ends capturing the media stream and storing data corresponding to the media stream. This is performed after step 50, i.e. when the handover is complete, at which point it is time to stop the media capturing. Optionally, there is an overlap of media stream capture between the source device and the target device to ensure there is no gap in media stream capture.

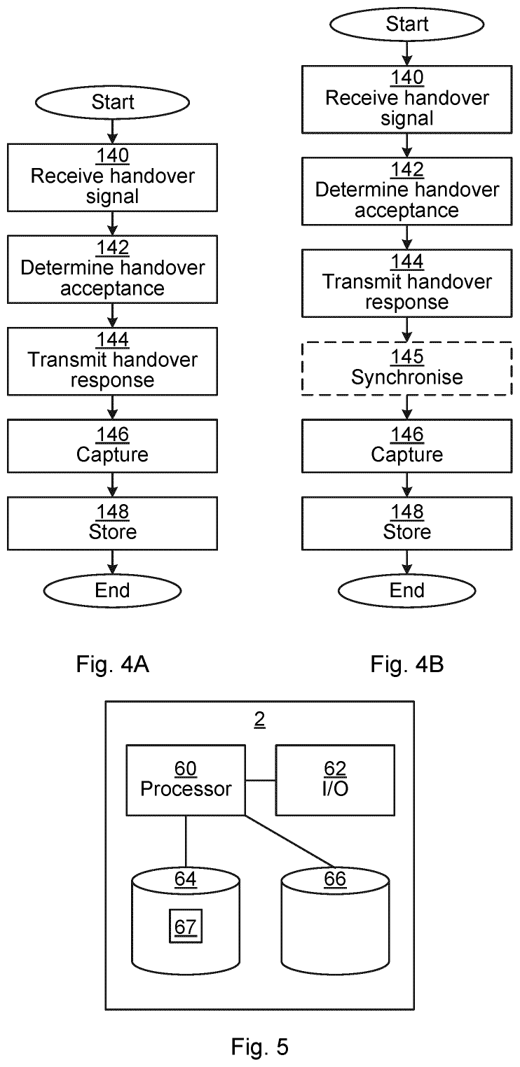

FIGS. 4A-B are flow charts illustrating embodiments of methods for performing a handover of capturing of a media stream, performed in a target device 2b. As explained above, the handover occurs from the source device 2a to a target device 2b. Also, as mentioned above, the media stream can comprise video data and/or audio data.

In a receive handover signal step 140, the target device 2b receives a handover signal from the source device 2a. The handover signal comprises an indication of a server location (e.g. in the form of a URI). Optionally, the handover signal comprises an indication of when the handover is to occur. Optionally, the indication of media stream storage comprises an indication of a file in which the target device 2b should store captured media stream data after the handover.

Optionally, the handover signal comprises configuration information of how the media stream should be captured by the target device 2b, e.g. by specifying a set of device parameters, e.g. for camera, view, etc., as mentioned above.

The handover signal can be received by reading data in the form of an optical code on a display of the source device 2a.

Optionally, the handover signal comprises a location indication (e.g. longitude/latitude) to allow the user of the target device 2b to know where media stream capturing is to occur, when the source device is not in the location as the source device. In this way, the user of the target device 2b can ensure to be in the indicated location by the time that the handover is to occur.

In a determine handover acceptance step 142, the target device 2b determines that handover is accepted. Optionally, prior to the acceptance, the target device 2b and the source device exchange messages to negotiate appropriate device parameters, e.g. for a camera, if the camera parameters do not match the desired parameters indicated in the handover signal, i.e. a capability exchange takes place.

In a transmit handover response step 144, the target device 2b transmits a handover response, indicating that handover is accepted by the target device 2b.

In a capture step 146, the target device 2b captures the media stream in accordance with the handover signal. When configuration information is available, this step comprises applying at least part of the configuration information, to the best ability of the target device 2b.

In a store step 148, the target device 2b storing data corresponding to the media stream in the server location, e.g. indicated by a URI. The target device 2b appends its media stream data to ensure a smooth transition in the media file at the handover. Optionally, the media stream data stored by the target device 2b is tagged with a different tag for media stream data stored by the source device 2a, to allow a post-processing process or media stream consumers to identify the different sources when combing the media stream data. Optionally, the target device 2b stores the data corresponding to the media stream in the same server location as for the source device, but in a different file, allowing a post-processing process to combine the two sources later.

Looking now to FIG. 4B, only new of modified steps, compared to FIG. 4A, are described.

In an optional synchronise step 145, the target device 2b synchronises with the source device 2a to ensure that the clocks of the source device 2a and the target device 2b are set to the same time. The synchronisation allows the reliable determination of the handover time at both the source device 2a and the target device 2b, ensuring no gaps in the resulting combined media file, when the source and target devices agree on a point in time or a time window when the handover will be executed.

The synchronisation can occur e.g. by both devices synchronising with the same Network Time Protocol (NTP) server or with different NTP servers that are directly or indirectly synchronised with each other. The synchronisation could also occur using local signalling between the source device 2a and the target device. Such local signalling can e.g. be based on light signalling (visible or infrared), sound signalling (audible or ultrasound) and/or radio-based signalling.

Using embodiments presented herein, an ongoing media stream capture can be handed over from one smartphone to another smartphone without any gaps in media stream recording. Moreover, there is no post-processing needed; the handover allows the target device to record its media capturing in the same file as the source device. This makes it possible for several user devices to act as one combined source rather than appending different camera sources, angles, settings into one common file.

FIG. 5 is a schematic diagram illustrating components of a user device 2, being the source device 2a or target device 2b of FIG. 1 according to one embodiment. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the methods described above with reference to FIGS. 3A-B (for the source device 2a) and to FIGS. 4A-B (for the target device 2b).

The memory 64 can be any combination of random-access memory (RAM) and/or read-only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 for communicating with external and/or internal entities. The I/O interface 62 also includes a user interface.

Other components are omitted in order not to obscure the concepts presented herein.

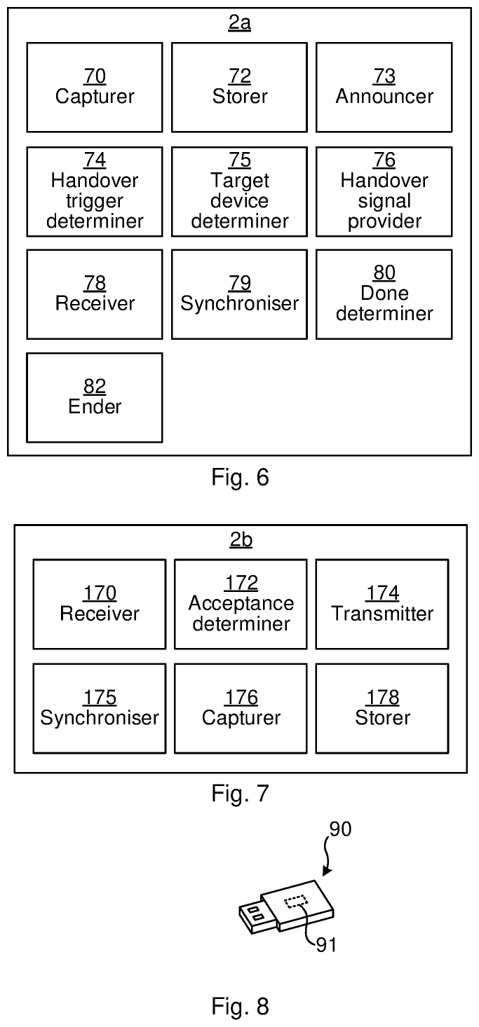

FIG. 6 is a schematic diagram showing functional modules of the source device 2a of FIG. 1 according to one embodiment. The modules are implemented using software instructions such as a computer program executing in the source device 2a. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

A capturer 70 corresponds to step 40. A storer 72 corresponds to step 42. An announcer 73 corresponds to step 43. A handover trigger determiner 74 corresponds to step 44. A target device determiner 75 corresponds to step 45. A handover signal provider 76 corresponds to step 46. A receiver 78 corresponds to step 48. A synchroniser 79 corresponds to step 49. A done determiner 80 corresponds to step 50. An ender 82 corresponds to step 52.

FIG. 7 is a schematic diagram showing functional modules of the target device 2b of FIG. 1 according to one embodiment. The modules are implemented using software instructions such as a computer program executing in the target device 2b. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 4A and 4B.

A receiver corresponds to step 140. An acceptance determiner 172 corresponds to step 142. A transmitter 174 corresponds to step 144. A synchroniser 175 corresponds to step 145 A capturer 176 corresponds to step 146. A storer 178 corresponds to step 148.

FIG. 8 shows one example of a computer program product 90 comprising computer readable means. On this computer readable means, a computer program 91 can be stored, which computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for performing a handover of capturing of a media stream from a source device to a target device, the method being performed in the source device and comprising:
capturing the media stream;
storing data corresponding to the media stream in a server location;
determining a target device;
providing a handover signal to the target device, the handover signal comprising an indication of the server location;
receiving a handover response, indicating that handover is accepted by the target device; and
determining that media capturing has been handed over to the target device.

2.-13. (canceled)

14. A source device for performing a handover of capturing of a media stream from the source device to a target device, the source device comprising:
a processor; and
a memory storing instructions that, when executed by the processor, cause the source device to:
capture the media stream;
store data corresponding to the media stream in a server location;
determine a target device;
provide a handover signal to the target device, the handover signal comprising an indication of the server location;
receive a handover response, indicating that handover is accepted by the target device; and
determine that media capturing has been handed over to the target device.

15. The source device according to claim 14, further comprising instructions that, when executed by the processor, cause the source device to:
end capturing the media stream and storing data corresponding to the media stream after the handover is complete.

16. The source device according to claim 14, wherein the handover signal comprises an indication of when the handover is to occur.

17. The source device according to claim 16, wherein the instructions to determine that the media capturing is handed over comprise instructions that, when executed by the processor, cause the source device to determine that media capturing has been handed over to the target device based on the time, according to the indication of when the handover is to occur, has passed.

18. The source device according to claim 16, further comprising instructions that, when executed by the processor, cause the source device to:
synchronise clocks with the target device.

19. The source device according to claim 14, wherein the instructions to provide the handover signal comprise instructions that, when executed by the processor, cause the source device to provide data in the form of an optical code on a display of the source device.

20. The source device according to claim 14, wherein the instructions to determine a target device comprise instructions that, when executed by the processor, cause the source device to determine a target device in a group of prioritised target devices, if such a target device is available.

21. The source device according to claim 14, wherein the instructions to determine a target device comprise instructions that, when executed by the processor, cause the source device to determine a target device based on a location of the source device and a location of the target device.

22. The source device according to claim 14, wherein the indication of server location comprises an indication of a file in which the target device should store captured media stream data after the handover.

23. The source device according to claim 14, wherein the handover signal comprises information of how the media stream should be captured, wherein the information comprises at least one of: a direction of media capture, a position for media capture, a time of when handover is to occur, one or more camera settings, and an object to focus on.

24.-28. (canceled)

29. A method for performing a handover of capturing of a media stream from a source device to a target device, the method being performed in the target device and comprising:
receiving a handover signal from the source device, the handover signal comprising an indication of a server location;
determining that handover is accepted;
transmitting a handover response, indicating that handover is accepted by the target device;
capturing the media stream in accordance with the handover signal; and
storing data corresponding to the media stream in the server location.

30.-36. (canceled)

37. A target device for performing a handover of capturing of a media stream from a source device to the target device, the target device comprising:
a processor; and
a memory storing instructions that, when executed by the processor, cause the target device to:
receive a handover signal from the source device, the handover signal comprising an indication of a server location;
determine that handover is accepted;
transmit a handover response, indicating that handover is accepted by the target device;
capture the media stream in accordance with the handover signal; and
store data corresponding to the media stream in the server location.

38. The target device according to claim 37, wherein the handover signal comprises an indication of when the handover is to occur.

39. The target device according to claim 38, further comprising instructions that, when executed by the processor, cause the target device to:
synchronise with the source device.

40. The target device according to claim 37, wherein the handover signal comprises configuration information of how the media stream should be captured by the target device and wherein the instructions to capture the media stream instructions that, when executed by the processor, cause the target device to apply at least part of the configuration information.

41. The target device according to claim 37, wherein the instructions to receive the handover signal comprise instructions that, when executed by the processor, cause the target device to read data in the form of an optical code on a display of the source device.

42. The target device according to claim 37, wherein the indication of media stream storage comprises an indication of a file in which the target device should store captured media stream data after the handover.

43. The target device according to claim 37, wherein the media stream comprises video data.

44. The target device according to claim 37, wherein the media stream comprises audio data.

45.-46. (canceled)
